(19) United States
(12) Patent Application Publication
(10) Pub. No.: US 2024/0330699 A1
(43) Pub. Date: Oct. 3, 2024

(54) SYSTEM AND METHOD FOR ACCELERATION OF DEEP-LEARNING COMPUTING WITH EDGE-TERMINAL COLLABORATION

(71) Applicant: HUAZHONG UNIVERSITY OF SCIENCE AND TECHNOLOGY, Wuhan City (CN)

(72) Inventors: Dezhong YAO, Wuhan City (CN); Sifan ZHAO, Wuhan City (CN); Hai JIN, Wuhan City (CN)

(21) Appl. No.: 18/519,518

(22) Filed: Nov. 27, 2023

(30) Foreign Application Priority Data
Mar. 31, 2023 (CN) 202310346947.7

(51) Int. Cl. G06N 3/092; G06N 20/20

(52) U.S. Cl. CPC G06N 3/092; G06N 20/20

(57) ABSTRACT

A system and method for acceleration of deep-learning computing with edge-terminal collaboration is provided, wherein the system includes at least one terminal device and at least one edge server. The terminal device is configured to, when being present in a service coverage of the at least one edge server, determine an inter-layer partitioning and/or intra-layer partitioning policy for a deep learning model based on first configuration information related to the terminal device itself and second configuration information related to the edge server. And the edge server is configured to execute the inter-layer partitioning and/or intra-layer partitioning policy for the deep learning model in response to an inference request message, so as to implement collaborative inference. In the present disclosure, by using the load-based random forest method to predict the execution time for the DNN model, more accurate prediction results can be obtained.

This application claims priority to Chinese Patent Application No. 202310346947.7 filed on Mar. 31, 2023, which is hereby incorporated by reference as if fully set forth herein.

### BACKGROUND OF THE INVENTION

### Field

The present disclosure generally relates to deep learning, and more particularly to a system and method for acceleration of deep-learning computing with edge-terminal collaboration.

### Description of Related Art

As machine learning has been increasingly applied in various applications, more and more image analysis tasks have been solved in deep learning (DL) models (DNNs), such as ResNet-50-based recognition of curved surfaces of workpieces, Faster-R-CNN-based skin analysis, 3D-R2N2-based scanning, Pix2VoX-based 3D reconstruction, etc. In addition, with the development of mobile devices and embedded devices, DL-based applications have been increasingly deployed in terminal devices. However, while computing resources in embedded and mobile devices become more and more powerful yet energy saving, it is still a challenging task to introduce computing-intensive DNN applications into terminal devices in terms of computing performance and storage capacity.

Some researchers have tried to accelerate DNN inference by offloading the entire DNN to a remote cloud server. In this case, a terminal device needing DNN inference may have the cloud take care of the whole inference process by sending raw data it collects to the cloud. The issue herein is that, as the terminal device sends all these private data to the cloud, privacy is under threat. Additionally, transmission of the usually bulky raw data from the terminal device to the remote cloud server can mean great time delay.

Development of the 5G technology has popularized edge server nodes and fog nodes in the forms of, for example, servers for deployment of base stations, home gate ways, etc. These edge server nodes provide terminal devices present in its coverage with available resources for computing and storage. On this basis, some studies argue that inference can be accelerated through offloading DNN partitions by means of collaboration between a terminal device and an edge server. First, these methods fail to consider inaccuracy in predicting execution time for layers in a DNN by a regression model trained using an equation in two variables in cases where multiple terminal devices compete for one edge server. Secondary, competition among multiple terminal devices for resources of a single edge node which is used as the object for data offloading can contrarily increase time of DNN inference after being accelerated.

For example, China Patent Application No. CN110309914A discloses a deep learning model inference accelerating method based on collaboration between an edge server and a mobile terminal. The known method, based on combination of model partitioning and model parsimony, trains and uses regression models to accurately estimate time delays caused by execution of network layers of DL models at edge servers and mobile terminals, thereby identifying exit points and partition points that satisfy time-delay requirements. As compared to existing methods that are based on cloud datacenters or about direct deployment on devices, the method of the existing patent not only enables high-performance and low-delay inference for DL models on mobile terminals but also achieves DL model inference where time delay and model accuracy are satisfyingly balanced. However, the known solution has some shortcomings.

First, the simple two-partition scheme is mainly focused on a model wherein computing budgets for different layer are regularly ascending or descending according to the order of the layers. For example, models like VGG and AlexNet are typically in the form that multiple convolutional layers are followed by a fully-connected layer, and computing budgets among the layers in the model are structurally high in the former part and low in the latter part, so the split points only have to exist in the latter few layers in cases of convolutional layers or the former few layers in cases of fully-connected layers. However, for many models composed of blocks, such as a NiN model that is composed of four blocks and has all fully-connected layers therein replaced by 1×1 convolutional layers, or an inception model that contains blocks Inception A, Inception B, and Inception C, each of which is composed of plural concurrent convolutional layers. Since the computing budgets are not evenly distributed according to the order of the layers, this simple two-partition scheme is less capable of balancing computing loads between edge servers and terminal devices. Particularly, highly loaded edge servers require multiple partitions to make use of resources of nodes with finer granularity.

Secondly, the execution times for DNN layers predicted by the regression model trained using an equation in two variables are inaccurate.

Thirdly, while a split point may be identified using a simple iterative algorithm, for cases involving multiple partitions, the complicated layer configuration leads to a spatially large set of split point positions, which prevents an iterative algorithm from identifying the optimal split point position set.

As another example, China Patent No. CN115034390B discloses an inference acceleration method based on cloud-edge collaboration for DL models. Specifically, it is a layer-based offloading method for DL models. The known method performs theoretical modeling for time delays for procedures throughout the process of DL model inference like computing, data transmission, data communication and generation a layer-based offloading policy, and decides the optimal layer-based offloading policy for the model that responds to computing tasks with the least time delay. Different from DL model frameworks centered on a physical end or centered on a cloud computing center, the known method combines edge computing and cloud computing, and offloading a DL model in layers to different edge computing nodes, so as to ensure computing accuracy while minimizing time delay for computing tasks. However, the known solution also has some shortcomings.

First, without using DNN intra-layer partitioning, it is difficult to partition computing budgets for DNN layers with fine granularity and this in turn prevents full use of high-load edge server resources. Secondly, without using reinforcement learning, in complicated applications with multiple edge servers, it is difficult to perform DNN partitioning fast and accurately according to loads of edge servers.

In order to address problems of the existing inference schemes for DL models, the present disclosure is proposed with the attempt to provide a better way to accelerated computing in virtue of edge-terminal collaboration.

Since there is certainly discrepancy between the existing art comprehended by the applicant of this patent application and that known by the patent examiners and since there are many details and disclosures disclosed in literatures and patent documents that have been referred by the applicant during creation of the present disclosure not exhaustively recited here, it is to be noted that the present disclosure shall actually include technical features of all of these existing works, and the applicant reserves the right to supplement the application with the related art more existing technical features as support according to relevant regulations.

### SUMMARY

In the existing art, acceleration of inference by partitioning and offloading a DNN based on collaboration between edge servers and terminal devices leave the following issues unaddressed.

First, regression models trained using equations in two variables are unable to provide accurate time prediction for DNN partitions in a case where multiple terminal devices compete for an edge server.

Secondly, when multiple terminal devices compete for resources of edge servers, they may use the same edge server as the common object for offloading, and the time required for acceleration of DNN inference can contrarily increase.

In view of the shortcomings of the existing art, the present disclosure provides a system for acceleration of deep-learning computing with edge-terminal collaboration, comprising at least one terminal device and at least one edge server. The terminal device is configured to: when being present in a service coverage of the at least one edge server, determine an inter-layer partitioning and/or intra-layer partitioning policy for a deep learning model based on first configuration information related to the terminal device itself and second configuration information related to the edge server. The edge server is configured to: execute the inter-layer partitioning and/or intra-layer partitioning policy for the deep learning model in response to an inference request message, so as to implement collaborative inference.

Preferably, the terminal device is configured to: predict an inference execution time for each neural network layer in the deep learning model based on a pre-trained random forest model, and decide a set of inter-layer split point positions based on an ILP algorithm, so as to minimize a total inference time between the terminal device and the edge server; and decide a set of intra-layer split point positions based on a reinforcement learning algorithm and the intra-layer partitioning policy, so as to minimize the inference time between/among the edge servers.

By using a random forest model and a DDPG model, the double confirmation ensures the optimal split points for inter-layer partitioning and/or intra-layer partitioning with the minimal inference time delay after offloading of DNN partitions.

In the present disclosure, a pre-trained random forest model is used to predict the inference execution time for every layer in the DNN, and then an ILP algorithm is used to identify the inter-layer split point position set. After partitioning, some partitions are left at terminal devices while the others are offloaded to edge servers. If loads of the edge servers are too large for the inference time delays for the partitions to satisfy user requirements, a pre-trained DDPG model is used additionally to determine the intra-layer split point position set of the deep learning model according to partitioning by height of the feature map and partitioning of the fully-connected layer by neuron quantity. Then the resulting partitions are assigned concurrently to multiple edge servers with relatively high loads. Therefore, the present disclosure can decide a collaboration policy that match the actual states of the terminal devices and the edge servers best, so as to minimize the total inference time, thereby preventing increased total inference time caused by overloading of edge servers.

Preferably, the inter-layer partition policy for the deep learning model at least comprises: partitioning the neural network layers of the deep learning model into at least two partitions according to inter-layer granularity.

In the existing art, a neural network is typically split into two partitions, yet this prevents full use of computing resources at both terminal devices and edge servers. The present disclosure instead partitions a neural network into three or more parts, and thereby maximizes benefits of collaboration between terminal devices and edge servers.

Preferably, the inter-layer partitioning policy for the deep learning model at least comprises: collecting execution data of at least one of the neural network layers generated when some of the terminal devices and the edge servers execute data sets of the deep learning model, and training the random forest model for execution time of the neural network layers.

Preferably, the terminal device is configured to decide the inter-layer split point positions at least through: using the random forest models to predict the execution time for the terminal device and the edge server to execute the neural network layers of the deep learning model; determining a transmission time for an intermediate feature vector between the terminal device and the edge server based on output data of each of the neural network layers of the deep learning model and communication bandwidth data of the edge server, determining a total offloading time for the partitions based on a sum of the inference execution time and the transmission time of the intermediate feature vector, and solving an optimal solution with the minimal total time based on the ILP algorithm, so as to identify an set of the optimal inter-layer split point positions. With computing such performed, the total inference time under edge-terminal collaboration can be minimized to obtain the most proper inter-layer split points.

Preferably, the intra-layer partitioning policy for the deep learning model at least comprises: performing partitioning according to an internal structure of at least one of the neural network layers of the deep learning model, so that at least two of the obtained partitions are deployed concurrently onto the corresponding edge servers.

Preferably, the intra-layer partitioning policy for the deep learning model at least further comprises: partitioning convolutional layers based on a height grid of a feature map, and partitioning a fully-connected layer based on the number of neurons.

The present disclosure further provides a method for acceleration of deep-learning inference with edge-terminal collaboration, the method at least comprises:

when a terminal device being present in a service coverage of at least one edge server, making the terminal device determine inter-layer partitioning and/or intra-layer partitioning policy for a deep learning model based on first configuration information related to the terminal device itself and second configuration information related to the edge server; and in response to inference request message, making the edge server execute the inter-layer partitioning and/or intra-layer partitioning policy of the deep learning model so as to implement collaborative inference.

Preferably, the method further comprises: predicting an inference execution time for a DNN layer based on a pre-trained random forest model, and deciding a set of inter-layer split point positions based on an ILP algorithm, so as to minimize a total inference time between the terminal device and the edge server; and deciding a set of intra-layer split point positions based on a reinforcement learning algorithm DDPG and the intra-layer partitioning policy, so as to minimize the inference time between/among the edge servers.

The method of the present disclosure has the following advantages. First, by using the load-based random forest method to predict the execution time for the DNN model, more accurate prediction results can be obtained. Secondly, by using the integer linear programming method, a DNN model can be partitioned by layer into multiple partitions instead of merely two partitions. Thirdly, using DDPG to further perform intra-layer partitioning on the partitions at edge server helps prevent increased inference time caused by overloading of server resources when a single edge server is used.

The present disclosure further provides a terminal device working with an edge server collaboratively for deep-learning computing. The terminal device is configured to: when being present in a service coverage of the at least one edge server, determine an inter-layer partitioning and/or intra-layer partitioning policy for a deep learning model based on first configuration information related to the terminal device itself and second configuration information related to the edge server, wherein the process includes: predicting an inference execution time for a DNN layer based on a pre-trained random forest model, and deciding a set of inter-layer split point positions based on an ILP algorithm, so as to minimize a total inference time between the terminal device and the edge server; and deciding a set of intra-layer split point positions based on a reinforcement learning algorithm DDPG and the intra-layer partitioning policy, so as to minimize the inference time between/among the edge servers.

In the present disclosure, the terminal device can further perform intra-layer partitioning on the partitions at the edge server using DDPG, so as to prevent increased inference time caused by overloading of server resources when a single edge server is used.

The DNN-based intra-layer partitioning further comprises: partitioning the convolutional layer based on the height grid of the feature map and partitioning the fully-connected layer based on the number of neurons.

Preferably, the DDPG model is pre-trained by: building three key elements that represent intra-layer partitioning of the DL model based on the Markov chain process, and training the DDPG model based on the three key elements; having the DDPG model, according to DNN intra-layer partitioning and based on the execution data, computing the total inference time among the edge servers, and determining the optimal intra-layer split point positions related to the minimal total inference time among the edge server.

With computing such performed, the total inference time among multiple high-load edge servers can be minimized to obtain a set of the most proper intra-layer split point positions.

### BRIEF DESCRIPTION OF THE DRAWINGS

FIG. 1 schematically illustrates partitioning according to a preferred mode of the present disclosure;

FIG. 2 schematically illustrates collaborative inference according to a preferred mode of the present disclosure;

FIG. 3 schematically illustrates the structure of a system for acceleration of deep-learning computing with edge-terminal collaboration according to a preferred mode of the present disclosure;

FIG. 4 schematically illustrates height-based partitioning of a feature map of a convolutional layer according to the present disclosure;

FIG. 5 schematically illustrates neuron-quantity-based partitioning of a fully-connected layer according to the present disclosure; and

FIG. 6 is a flow chart of a method for acceleration of deep-learning computing with edge-terminal collaboration according to a preferred mode of the present disclosure.

### DETAILED DESCRIPTION

The present disclosure will be further detailed below with reference to accompanying drawings and particular embodiments.

In the existing art, acceleration of inference by partitioning and offloading a DNN based on collaboration between edge servers and terminal devices leave the following issues unaddressed.

First, regression models trained using equations in two variables are unable to provide accurate time prediction for DNN partitions in a case where multiple terminal devices compete for an edge server.

Secondly, when multiple terminal devices compete for resources of edge servers, they may use the same edge server as the common object for offloading, and the time required for acceleration of DNN inference can contrarily increase.

Hence, the present disclosure herein addresses the foregoing issues by providing a system and a method for acceleration of deep-learning computing with edge-terminal collaboration that allows edge servers to be reasonably configured so as to prevent increase of the inference time caused by resources competition of edge servers.

The present disclosure further provides a terminal device that works with an edge server collaboratively for inference and a method for executing the terminal device. The present disclosure further provides an edge server suitable for a method for acceleration of deep-learning computing with edge-terminal collaboration of the present disclosure.

Some technical terms used herein are defined as below.

An edge server provides a channel for a user to access a network and to communicate with other server devices. The edge server may refer to a set of servers each providing single function, such as a firewall server, a cache server, a load balancing server, a DNS server, etc.

A terminal device refers to an input/output device that is connected to a computer system and is usually relatively remote from the computer. The terminal device is preferably a smart terminal device. The smart terminal device is capable of operating a deep learning model and work with an edge server collaboratively to implement inference. The smart terminal device may be a smart device. The smart device may be for example a device equipped with a chip and a processor so as to be capable of communication. The smart device may be a terminal device capable of computing, such as a computer, a laptop, a smartphone, smart glasses, a smart watch, or a smart bracelet.

A deep learning model is framed by an artificial neural network and based on an algorithm that performs representation learning on data. It usually comprises an input layer, intermediate layers, and an output layer. The intermediate layers may include a convolutional layer, a pooling layer, a noise layer, and an activating layer. The output layer is usually a fully-connected layer (a Dense layer), which implements classification/regression tasks by means of controlling dimensions.

A random forest model is a commonly used machine learning algorithm, which is an integration algorithm composed of different decision trees that are not related to each other. When new samples enter the forest model, the decision trees in the forest conduct determination and classification respectively. Every decision tree will get its own classification result, and the random forest will take the most frequently appearing classification result among the decision trees as its own final result. A random forest may be used for high-dimensional data without the needs for dimensionality reduction and feature selection. It is also advantageous for being less tending to overfit, fast to train, and favorable to concurrency.

The Markov Decision Process (MDP) is a random process in which a state space transforms from one state to another state. Therein, the state distribution of a coming state is exclusively determined by the present moment and has nothing to do with the past. Specifically, for a problem divided into several phases, the state in Phase k can be obtained from the state in Phase k+1 through a state transition equation, and is independent of any other state, which can be expressed as P[St+1|St]=P[St+1|S1, . . . , St]. States in a reinforcement learning problem also follow the Markov property. This is, in the current state St an action at is taken and then transformation to the next state St+1 happens, without considering the previous states St−1, . . . , S1.

Reinforcement learning refers to the process where an agent in a complicated uncertain environment maximizes the reward it can earn. This is about sensing how a state of the environment rewards an action and accordingly directing a better action, thereby acquiring the maximum return. A typical Markov Decision Process (MDP) is a common model for reinforcement learning. Most used algorithms for reinforcement learning include: the table-based Q-Learning algorithm without participation of any neural network, the value-based Deep Q Network (DQN) algorithm, the policy-based Policy Gradient (PG) algorithm, and actor critic algorithms that combine the value basis and the policy basis (e.g., DDPG, and A3C).

Deep Deterministic Policy Gradient (DDPG) is a deep deterministic policy gradient algorithm, addressed for solving continuous action control problems. DDPG is all about being deterministic, and this is demonstrated by that continuous actions output a certain value. When actions are discrete, the strategic function outputs the probability for each action to happen with the attempt to maximize long-term returns. When actions are continuous, with the objective to maximize long-term returns, only a certain value can be output, which represents a specific action, thereby becoming a deterministic policy. Among reinforcement learning algorithms, Q-Learning, DQN and PG are used to decide discrete action problems, while DDPG is a value- and policy-based actor critic algorithm to be used in decision making in a Markov chain to solve decision making problems where continuous actions are involved. Given that a DNN has many layers every having different configuration information, leading to a huge intra-layer split point set and numerous decision-making actions, an algorithm based on discrete action problems is inapplicable, so the present disclosure adopts a DDPG algorithm relevant to continuous actions.

An ILP algorithm is an integer linear programming algorithm, which requires a part or all of decision variables to each be an integer. Since a DNN inter-layer split point position is an integral value, it is possible to decide a split point variable set using the ILP method in the present disclosure.

Partitioning with inter-layer granularity involves regarding every layer in a DNN as an independent unit, such as the convolutional layer or the fully-connected layer, and performing partitioning on the DNN by layers.

Partitioning with intra-layer granularity involves regarding an internal structure of every layer in a DNN as a unit, such as one or more neurons in the fully connected layer of a DNN, or one or more columns in a feature map in the convolutional layer, and performing partitioning on the DNN by internal structures of layers.

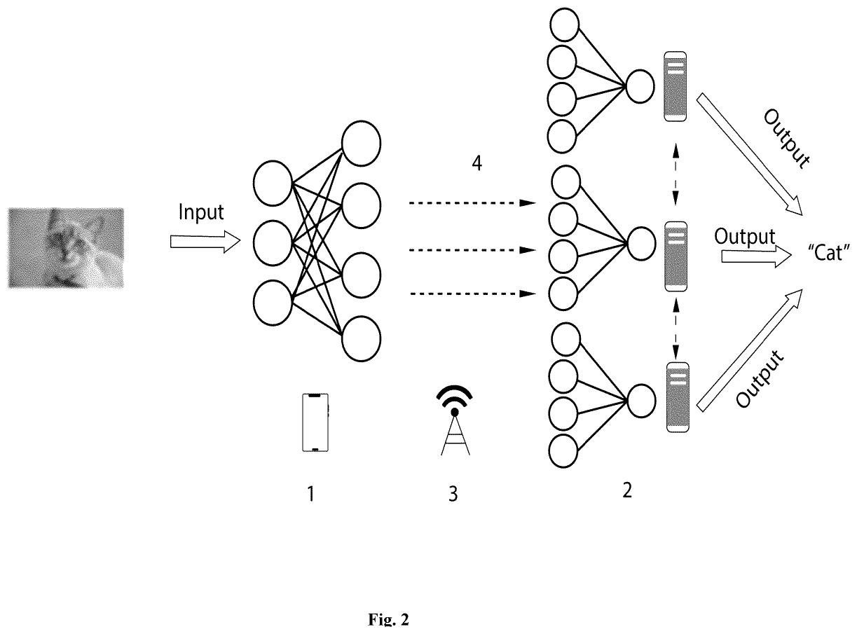

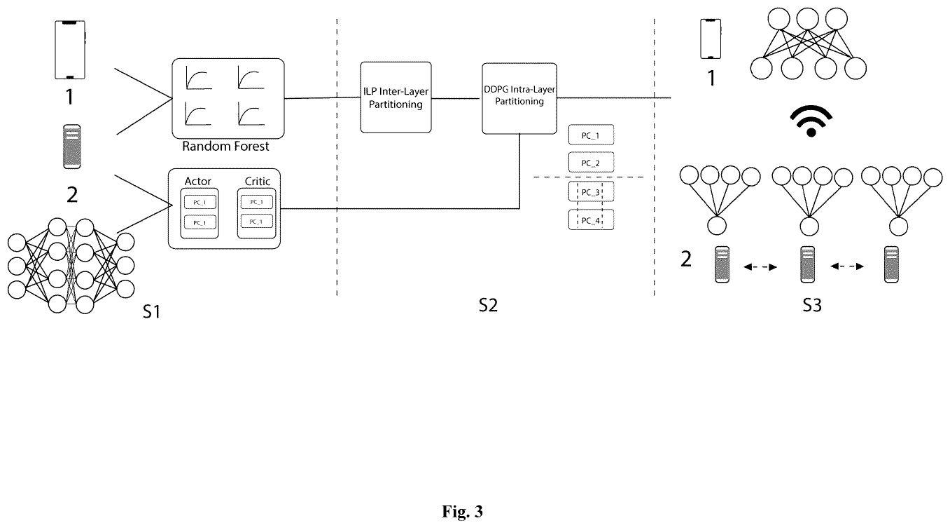

The present disclosure provides a system for acceleration of deep-learning computing with edge-terminal collaboration, as shown in FIG. 2 and FIG. 3, comprising at least one terminal device 1 and at least one edge server 2.

The terminal device 1 is configured to: when being present in a service coverage of the at least one edge server 2, determine an inter-layer partitioning and/or intra-layer partitioning policy for a deep learning model based on first configuration information related to the terminal device itself and second configuration information related to the edge server 2.

The edge server 2 is configured to: execute the inter-layer partitioning and/or intra-layer partitioning policy for the deep learning model in response to an inference request message, so as to implement collaborative inference.

Specifically, the terminal device 1 can decide to use the inter-layer partitioning policy or the intra-layer partitioning policy, or the both, for collaborative inference, according to resource competition among multiple terminal devices and edge servers 2.

Normally, when connection of a terminal device and an edge server does not incur competition for resources, estimation of the collaborative inference time for this terminal device and this edge server is normal and predictable. However, if there are multiple terminal devices connected to a few edge servers, and consequently connection between two or more terminal devices and the same edge server incurs competition, the collaborative inference time between the terminal devices and the edge server can be longer than predicted. In this case, using inter-layer partitioning exclusively can cause inefficient inference.

Preferably, the terminal device 1 is configured to conduct inter-layer partitioning or intra-layer partitioning.

Inter-layer partitioning is conducted as below. A pre-trained random forest model is used to predict the execution time for every layer of a deep learning model to execute at the terminal device and the edge server. On this basis, an integer linear programming algorithm (ILP) is used to identify an inter-layer split point position set, so as to minimize a total inference time between the terminal device and the edge server.

Intra-layer partitioning is conducted as below. A pre-trained reinforcement learning DDPG model is used to identify an intra-layer split point position set for the deep learning model according to height-based partitioning of a feature map and a neuron-quantity-based partitioning policy for the fully-connected layer, so as to minimize the total inference time among high-load edge servers. Specifically, off-line training comprises a first step about off-line training of a random forest model and a second step about off-line training of a reinforcement learning DDPG model.

At S1, off-line training is performed.

At S1.1, the random forest model is trained and used to estimate the execution time of a neural network layer at the edge server and at the terminal device.

This is specifically about collecting execution data of the neural network layers generated when several terminal devices and several edge servers execute the deep learning model, and training the random forest model accordingly.

Preferably, for each type of layers, a random forest prediction model is established, including a random forest model for the convolutional layer (CL), a random forest model for the pooling layer (PL), a random forest model for the activating layer (AL), and a random forest model for the fully-connected layer (FL).

Specifically, data sets of the deep learning models are executed at several terminal devices and several edge servers, and execution time data about collecting when the terminal devices and the edge servers execute the data sets for every layer of the neural networks. The collected execution time data and hyperparameter configuration information for different types of layers are used as input data for training the individual random forest prediction models.

Preferably, the data sets of the deep learning models come from neural network sets generated through neural architecture search (NAS). NAS uses algorithms to autonomously design neural networks with high-performance architecture according to sample sets. In particular, NAS can, according to input models, generate various neural network model variants based on a common model architecture yet having different hyperparameters. For example, with VGG16 input as reference, NAS can generate various neural network model variants sharing the same VGG16-based structure but have different hyperparameters (e.g., the kernel size, the stride, the padding pattern, etc.). The set of these model variants contains numerous convolutional layers having different hyperparameter configurations, pooling layers having different hyperparameter configuration, activating layers having different hyperparameter configuration, and fully-connected layers having different hyperparameter configuration. Therefore, by executing the model variant set at terminal devices and edge servers, a large execution time data set for different types of layers having different hyperparameter configurations can be obtained with a quantity large enough to train random forest prediction models for all types of the existing layers.

Preferably, collecting the execution time data for the deep learning model is achieved by collecting the execution time for every type of layers while adjusting CPU\GPU usage at the terminal devices and the edge servers.

Specifically, 12 representative DNN models (such as AlexNet, VGG, DenseNet, ResNet, etc.) have been off-line collected at ImageNet2012. With this, NAS is used to generate data sets for 500 model variants. The data sets for the model variants are executed at terminal devices and edge servers with changing GPU\CPU usage, and the execution times for different types of layers are collected to be used as input data sets for random forest models for different types of layers. Then the data sets are used to train random forest models for very type of layers (CL, FL, PL, and AL). The trained random forest models can be used to predict the inference execution time of a DNN layer under different loads at edge servers and terminal devices. The random forest model has only to be trained for one time and after that it can be used for prediction of execution of DNN layers at terminal devices and edge servers.

At S1.2, a reinforcement learning DDPG model is trained and used to decide intra-layer split point positions.

Specifically, based on the Markov chain process, three key elements for implementing intra-layer partitioning in a scene involving plural edge servers are established, and the DDPG model is trained with the three key elements and the execution time data.

Specifically, the problem of deciding the intra-layer split point position set is described as a Markov chain process (MDP). Therein, actions represent partitioning feature maps of convolutional layers using height grids and partitioning fully-connected layers according to the numbers of neurons. States represent the height and the width of feature maps of the convolutional layers, the quantity of neurons in the fully-connected layer, the workloads of edge servers (GPU\CPU usage) and the total time for edge servers to execute inference. Rewards represent the execution time returns which the current states can bring about when actions are taken.

Further, according to the Markov chain process, three key elements are established, namely the state, the action, and the reward. Therein, state={model layer quantity, neuron quantity, feature map height, feature map width, edge server quantity, edge server execution time}, action={feature map height split point, neuron quantity split point},

$$reward = \{ \begin{matrix}0 ( T > t ) \\ \frac{1}{T} ( T \leq t )\end{matrix} ,$$

where t represents the time limit acceptable to the user.

Further, according to the three established MDP key elements, a DDPG decision algorithm is developed. In reinforcement learning, a classic DDPG algorithm includes two components, namely the actor and the critic, which are two neural networks. The actor is for executing a specific action (corresponding to the action in the three MDP key elements), and the critic evaluates the reward caused by the action (corresponding to the reward in the three MDP key elements), thereby determining whether the action needs to be taken. The actor is designed as four fully-connected layers, and the critic is also designed as four fully-connected layers. Then the data set for 500 model variants is operated at three edge servers, while CPU\GPU usage of the edge server are changed, so as to train the DDPG to convergence. The data set of model variants are generated at the step S1.1.

During the on-line optimization stage, the trained DDPG algorithm autonomously decides the most suitable intra-layer split point position sets for convolutional layers and fully-connected layers in heavily-loaded edge servers, thereby accomplishing intra-layer partitioning. The DDPG algorithm has only to be trained for one time and after that it can be used for decisions about intra-layer split point position sets among edge servers.

At S2, on-line optimization is achieved by:
based on the sum of inference execution time predicted by the random forest model for a layer and the transmission time for the intermediate feature vector, building an integer linear programming mathematical model, wherein the result obtained from the integer linear programming mathematical model is right the optimal inter-layer split point position set, and/or
based on convolutional layer feature map height-grid-partitioning and fully-connected layer neuron-quantity-partitioning, according to DDPG algorithm deciding intra-layer split point position set.

At S2.1, based on the sum of the inference execution time predicted by the random forest model for the layer and the transmission time of the intermediate feature vector, an integer linear programming mathematical model is built and the result obtained from this model is right the optimal inter-layer split point position set.

Specifically, the execution time for every layer of the deep learning model DNN at a terminal device as predicted by the random forest model is set as T_{end}^{exc}. The time for executing inference at an edge server as predicted by the random forest model is set as Tₛₑᵣᵥₑᵣ^{exc}. The size of the output data of every layer of the DNN of the deep learning model as collected is set as O. The bandwidth for communication between the terminal device and the edge server is set as B. According to the bandwidth B and the output data O of every layer, the transmission time for the intermediate feature vector to execute at the terminal device and the edge server can be determined as Tₜᵣₐₙₛ.

The total time Tₜₒₐₗ of the partition offloading policy is the sum of the inference execution time and the transmission time for the intermediate feature vector:

$${T}_{total} = {\sum }_{g = 1}^{n} {\sum }_{m = 1}^{n} {\sum }_{k = g + 1}^{n} [ {e}_{m , g} {T}_{end}^{exc} + {s}_{m , g} {T}_{server}^{exc} + {e}_{m , g} {s}_{g + 1} {T}_{trans} ] ,$$

where n denotes the number of layers in the DNN, m, g, and k each represent a layer in the DNN, and the two variables e and s represent the layers to be executed at the user terminal device and the layers to be executed at the edge server. For example, e_{m,g}=1 means that the m^{th} layer to the g^{th} layer of the DNN are to be executed at the terminal device, and e_{m,g}=0 means that the m^{th} layer to the g^{th} layer of the DNN are not to be executed at the terminal device.

For the convex optimization problem minTₜₒₜₐₗ, optimal inter-layer split points can be identified using an ILP algorithm. After partitioning is performed at the split point, W_{end} is deployed onto the terminal device and Wₛₑᵣᵥₑᵣ is deployed onto the edge server.

The present disclosure uses random forest models trained in the off-line stage to predict the execution times for layers of a learning model DNN, and uses an TLP algorithm to decide how the deep learning model DNN should be partitioned and deployed to terminal devices and edge servers according to inter-layer granularity partitioning. The present disclosure uses reinforcement learning method trained in the off-line stage to determine how the deep learning model DNN should be partitioned and deployed to edge servers according to intra-layer granularity partitioning.

At S2.2, based on height grid partitioning for feature maps of convolutional layers and neuron quantity partitioning for fully-connected layers, an intra-layer split point position set is decided according to a DDPG algorithm.

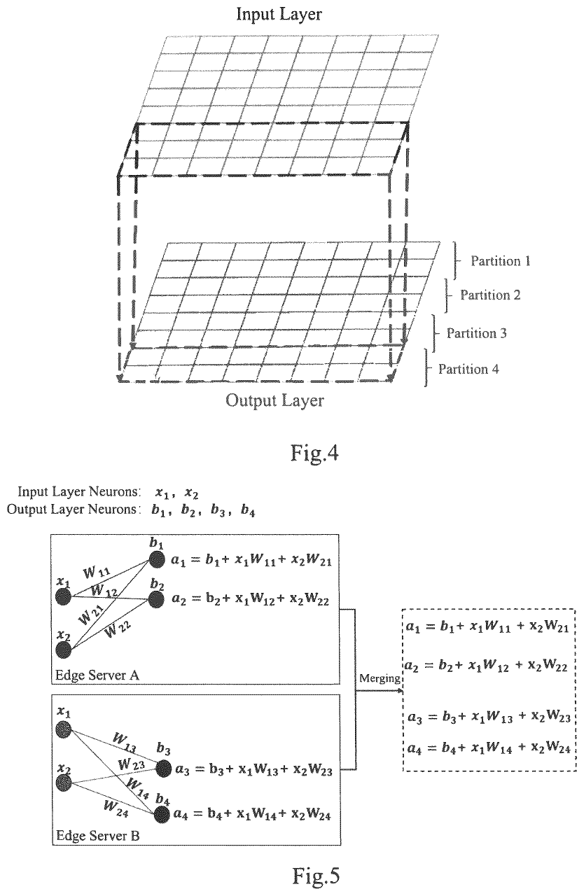

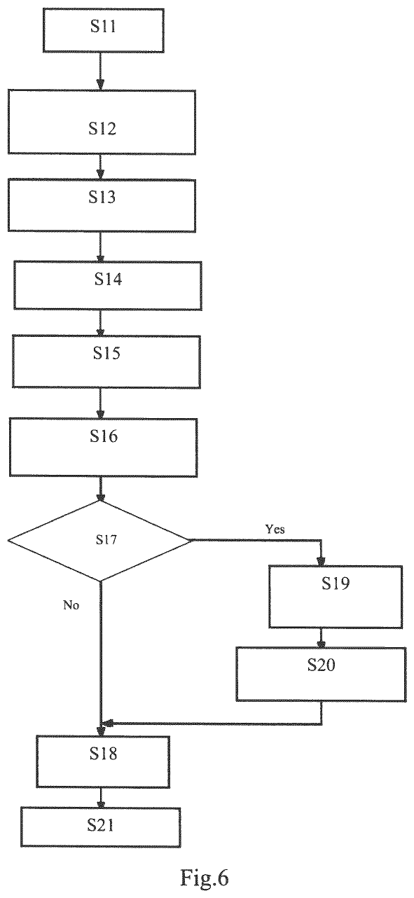

Preferably, as shown in FIG. 4, computing overheads for convolutional layers come from convolutional operation of feature maps, so partitioning based on height grid of feature maps is applied to convolutional layers.

Specifically, since computing overheads for convolutional layers come from convolutional operation of feature maps, the partitioning scheme based on height grids of feature maps is suitable. For example, in a scene with three high-load edge servers, intra-layer partitioning for a convolutional layer can be conducted as shown in FIG. 4. For a 8×8 convolutional layer, according to the DDPG algorithm of the present disclosure, the trained DDPG according to state={model layer quantity=1, feature map height=8, feature map width=8, edge server quantity=4, edge server load (GPU\CPU usage)=(w₁, w₂, w₃, w₄), edge server execution time=T, convolutional layer partitions=[(h₁)]}, the actor performs the first round of action={feature map height split point (1, 3, 4)}. Partitioning generates Partition 1=[h₁], Partition 2=[h₂,h₃], Partition 3=[h₄], and Partition 4=[h₅,h₆,h₇,h₈]. The execution time T₁ for partitioning is evaluated by the critic and the reward determines that T₁>t, T₁<T, so the reward is 0.

Then the DDPG model updates the state={model layer quantity=1, feature map height=8, feature map width=8, edge server quantity=4, edge server load (GPU\CPU usage)=(w₁¹, w₂¹, w₃¹, w₄¹), the edge server execution time=T₁, the convolutional layer partitions=[(h₁),(h₂,h₃),(h₄),(h₅,h₆,h₇,h₈)]}.

The actor performs the second round of action={feature map height split point (2,3,4)}. Partitioning generates Partition 1=[h₁,h₂], Partition 2=[h₃], Partition 3=[h₄], Partition 4=[h₅,h₆,h₇,h₈]. The execution time T₂ for partitioning is evaluated by the critic and the reward determines that T₂<t, T₂<T₁, so the reward is 0+1/T₂=1/T₂.

Then the DDPG model updates the state={model layer quantity=1, feature map height=8, feature map width=8, edge server quantity=4, edge server load (GPU\CPU usage)=(w₁², w₂², w₃²,w₄²) the edge server execution time=T₂, and the convolutional layer partitions=[(h₁,h₂),(h₃),(h₄),(h₅,h₆,h₇,h₈)]}.

The actor performs the third round of the action={feature map height split points (2,4,6)}, after partitioning being Partition 1=[h₁,h₂], Partition 2=[h₃,h₄], Partition 3=[h₅,h₆], and Partition 4=[h₇,h₈]. Then the critic estimates the execution time T₃ for partitioning results. At last, the reward determined that T₃<t, T₃>T₂, so this reward is 1/T₃.

With the off-line trained DDPG model, actions are continuously taken with the attempt to achieve the maximum accumulative value of rewards. Thus, multiple rounds of actions are performed until the maximum accumulative value of rewards become steady, and this is the convergent state. The partitioning result generated at this moment provides the optimal selections for partitions. For example, in FIG. 4, the result upon convergence is to partition the convolutional layer at output layer according to the height H partitioning into Partition 1=[h₁,h₂], Partition 2=[h₃,h₄], Partition 3=[h₅,h₆], and Partition 4=[h₇,h₈]. The four partitions are placed onto four edge servers, respectively.

Preferably, since computing overheads for fully-connected layers come from the synergistic operation among neurons (e.g., addition and multiplication), partitioning according to the number of neurons is implemented quantity.

Specifically, in a scene with two high-load edge servers, intra-layer partitioning of a fully-connected layer is shown in FIG. 5. Therein, the input layer contains two neurons x₁ and x₂, and the output layer contains four neurons b₁, b₂, b₃ and b₄. With the trained DDPG algorithm of the present disclosure, according to state={model layer quantity=1, input neurons=2, output neurons=4, edge server quantity=2, edge server load (GPU\CPU usage)=(w₁, w₂), the edge server execution time=T, fully-connected layer partitions=[(b₁,b₂,b₃,b₄)]}, the actor performs the first round of action={output neuron split point (1)}. Partitioning generates Partition 1=[b₁], and Partition 2=[b₂,b₃,b₄]. The execution time for partitioning is evaluated by the critic, and the reward determines that T₁>t, T₁<T, so the reward is 0. Then DDPG updates the state={model layer quantity=1, input neurons=2, output neurons=4, edge server quantity=2, edge server load (GPU\CPU usage)=(w₁¹, w₂¹), edge server execution time=T₁, fully-connected layer partitions=[(b₁), (b₂,b₃,b₄)]}. The actor performs the second round of action={output neuron split point (2)}. Partitioning generates Partition 1=[b₁,b₂], and Partition 2=[b₃,b₄]. The execution time for partitioning is evaluated by the critic, and the reward determines that T₂<t, T₂<T₁, so the reward is 1/T₂. With the off-line trained DDPG model, actions are continuously taken with the attempt to achieve the maximum accumulative value of rewards. Thus, multiple rounds of actions are performed until the maximum accumulative value of rewards become steady, and this is the convergent state. The partitioning result generated at this moment provides the optimal selections for partitions. For example, in FIG. 5, the result upon convergence is to partition the neurons of the output layer into two partitions, namely Partition 1=[b₁,b₂] and Partition 2=[b₃,b₄]. The two partitions are placed onto an edge server A and another edge server B, respectively. The input layer neurons x₁, x₂ and their copies are placed on the edge servers A and B, respectively. By merging the output layer results, a complete output vector can be obtained. In the present disclosure, intra-layer partitioning is mainly considered for fully-connected layers and convolutional layers. This is because other layers, like pooling layers and activating layer, have their storing and computing capacity much smaller than those of fully-connected layers and convolutional layers, so the computing overheads for pooling layers and activating layers are essentially insufficient to cancel out the overheads for partitioning operations. Additionally, in the present disclosure, intra-layer partitioning both for convolutional layers and fully-connected layers are not limited to two or three partitions. The number of partitions is determined by the trained DDPG algorithm according to the number, loads and execution times of edge servers in actual scenes.

Preferably, the inter-layer partitioning policy for the deep learning model at least comprises: partitioning the neural network of the deep learning model into at least three partitions according to inter-layer granularity.

Specifically, the present disclosure uses the ILP algorithm to identify multiple split points for partitioning with inter-layer granularity in the neural network, thereby generating multiple partitions. For example, a neural network model may be split into three partitions, namely W1, W2, and W3, wherein W1 and W3 are deployed on a terminal device, and W2 is offloaded to an edge server. It is apparent that the multi-partition inter-layer partitioning scheme can maximize the benefits of collaboration between terminal devices and edge servers.

In the present disclosure, intra-layer partitioning is performed on a deep learning model as detailed below.

In cases where the edge server is a device limited in computing resources, such as a router, or where competition among multiple clients leads to imminent overload of edge server resources and limits the ability of an edge server to accelerate inference for a deep learning model DNN, multiple nearby edge servers have to execute a DNN inference task cooperatively.

Intra-layer partitioning is finer than inter-layer partitioning in terms of granularity. Inter-layer partitioning is a serial partitioning program in which partitioning for a deep learning model DNN is executed layer by layer. Intra-layer partitioning is about partitioning the internal structure of a certain layer in a deep learning model DNN, so that the resulting partitions can be concurrently deployed onto plural edge servers. Computing overheads related to a DNN model mainly come from the convolutional layer CL and the fully-connected layer FL, so the two layers are where intra-layer partitioning is focused on.

Preferably, the intra-layer partitioning policy for the deep learning model comprises: performing partitioning according to an internal structure of at least one of the neural network layers of the deep learning model, so that the split at least two partitions are deployed concurrently onto the corresponding edge servers 2.

Preferably, the intra-layer partitioning policy for the deep learning model further comprises: partitioning convolutional layers based on a height grid of a feature map, and partitioning a fully-connected layer based on a number of neurons.

Specifically, the computing overheads at the convolutional layer CL come from convolutional operation for feature maps, so the partitioning scheme used is partitioning based on height grids of feature maps. Since computing overheads for fully-connected layers come from the synergistic operation among neurons, partitioning according to the number of neurons is implemented quantity. Intra-layer partitioning thus can make full use of resources across multiple edge servers.

For example, this example comprises three high-load edge servers and one terminal device. The deep learning model DNN is for example the first 5 layers of the AlexNet. The edge server is each equipped with hardware resources such as a CPU and a GPU. Connection between a terminal device and an edge server and between two different edge servers is achieved using Wi-Fi.

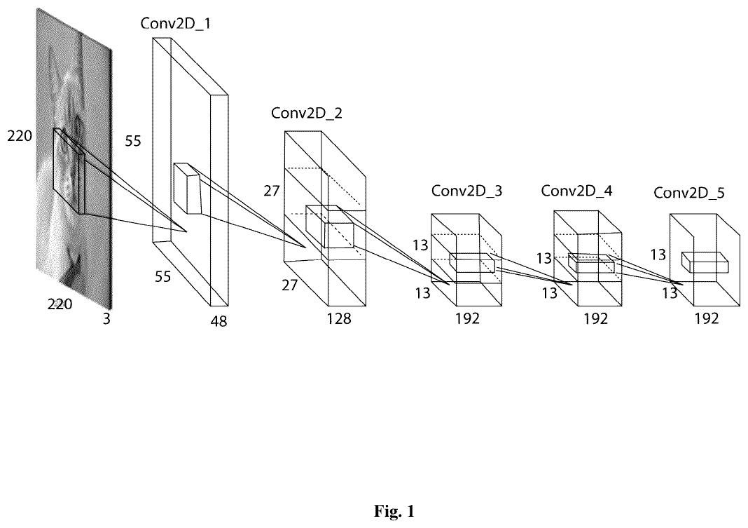

(1) To a random forest model pre-trained off line, GPU resources of the edge server and the terminal device and 5 layers of the DNN are input. The random forest model outputs execution times for each layer to execute at the terminal device and at the edge server. The inter-layer partitioning problem is described as a convex optimization problem. Then, two split points are identified using the ILP algorithm. The two split points are located between conv_1 and conv_2 and between conv_4 and conv_5, respectively, as shown in FIG. 1.

The deep learning model DNN model is partitioned into three partitions according to inter-layer granularity. The partitions are Partition W1, Partition W2 and Partition W3. Partition W1 contains Layer conv_1, Partition W2 contains Layers conv_2, conv_3, and conv_4 layer, and Partition W3 contains Layer conv_5. Therein, Partition W1 and Partitions W3 are deployed on the terminal device, and Partition W2 is offloaded onto the edge server.

(2) The edge server performs intra-layer partitioning on the offloaded partition W2. The DDPG model trained in the off-line stage partitions convolutional layers conv_2, conv_3 and conv_4 by the height of the feature maps into three partitions according to the layer quantity, the neuron quantity, the feature map height, the feature map width, and the bandwidth among the edge servers, as well as information on CPU and GPU, of the deep learning model DNN in Partition W2 as shown in FIG. 1. The resulting partitions are then deployed to three edge servers, respectively.

Collaborative inference is as shown in FIG. 2. When the terminal device issues an inference request, an inference task is executed according to the partitions of the deep learning model DNN formed during on-line optimization. The terminal device inputs raw data to Partition W1. Partition W1 output the intermediate feature vector to the three edge servers for their respective execution. The three edge servers communicate the intermediate feature data during execution, and then the inference results are merged before sending to the terminal device. Partition W3 at the terminal device receives the data, and at last generates the inference result.

The present disclosure further provides a method for acceleration of deep-learning computing with edge-terminal collaboration, and an embodiment thereof is depicted in FIG. 4.

The method begins with S11.

At S12, a terminal device enters the service coverage of an edge server.

The edge server and the terminal device have both been registered in a QingCloud platform or a Huawei-operated IoTEdge platform, so that when the terminal device is present in the service coverage of the edge server, QingCloud or IoTEdge provides inter-connection to them. QingCloud and IoTEdge are both platforms providing IoT networks and edge nodes with services, mainly about inter-connection between registered edge servers and registered terminal devices according to MQTT protocols. However, in the present disclosure, terminal devices and edge servers may be connected using other schemes than the two exemplificative ones.

At S13, the terminal device acquires second configuration information related to a nearby edge server.

After the terminal device is connected to the edge server, the edge server informs the terminal device of CPU usage (if a GPU is used), so that the terminal device has knowledge on the load of the edge server.

At S14, the ILP algorithm is executed.

At S15, the deep learning model DNN after inter-layer partitioning is offloaded.

At S16, the edge server receives at least one partition offloaded by the terminal device.

At S17, the edge server determines how serious resource competition is, or, determines whether the inference execution time is satisfying in view of user requirements.

At S18, where resource competition is moderate, and the inference execution time is satisfying in view of user requirements, the inference request from the user is responded with execution.

At S19, if resource competition is serious to the extent that the inference execution time is not satisfying in view of user requirements, the DDPG algorithm is executed.

At S20, concurrent intra-layer partitioning is performed on plural edge servers.

At S21, after the edge server merges the output results, at least one edge server returns the DL model inference result to the terminal device.

It is to be noted that the particular embodiments described previously are exemplary. People skilled in the art, with inspiration from the disclosure of the present disclosure, would be able to devise various solutions, and all these solutions shall be regarded as a part of the disclosure and protected by the present disclosure. Further, people skilled in the art would appreciate that the descriptions and accompanying drawings provided herein are illustrative and form no limitation to any of the appended claims. The scope of the present disclosure is defined by the appended claims and equivalents thereof. The disclosure provided herein contains various inventive concepts, such of those described in sections led by terms or phrases like “preferably”, “according to one preferred mode” or “optionally”. Each of the inventive concepts represents an independent conception and the applicant reserves the right to file one or more divisional applications therefor.

What is claimed is:

1. A system for acceleration of deep-learning computing with edge-terminal collaboration, the system comprising at least one terminal device and at least one edge server, wherein
the terminal device is configured to:
when being present in a service coverage of the at least one edge server, determine an inter-layer partitioning and/or intra-layer partitioning policy for a deep learning model based on first configuration information related to the terminal device itself and second configuration information related to the edge server; and
the edge server is configured to:
execute the inter-layer partitioning and/or intra-layer partitioning policy for the deep learning model in response to an inference request message, so as to implement collaborative inference.

2. The system of claim 1, wherein the terminal device is configured to:
predict an inference execution time for each neural network layer in the deep learning model based on a pre-trained random forest model, and decide a set of inter-layer split point positions based on an ILP algorithm, so as to minimize a total inference time between the terminal device and the edge server; and
decide a set of intra-layer split point positions based on a reinforcement learning algorithm and the intra-layer partitioning policy, so as to minimize the inference time between/among the edge servers.

3. The system of claim 2, wherein the inter-layer partition policy for the deep learning model at least comprises:
partitioning the neural network layers of the deep learning model into at least two partitions according to inter-layer granularity.

4. The system of claim 3, wherein the intra-layer partitioning policy for the deep learning model at least comprises:
collecting execution data of at least one of the neural network layers generated when some of the terminal devices and the edge servers execute data sets of the deep learning model, and training the random forest model for execution time of the neural network layers.

5. The system of claim 4, wherein the terminal device is configured to decide the inter-layer split point positions at least through:
using the random forest models to predict the execution time for the terminal device and the edge server to execute the neural network layers of the deep learning model;
determining a transmission time for an intermediate feature vector between the terminal device and the edge server based on output data of each of the neural network layers of the deep learning model and communication bandwidth data of the edge server,
determining a total offloading time for the partitions based on a sum of the inference execution time and the transmission time of the intermediate feature vector, and
solving an optimal solution with the minimal total time based on the ILP algorithm, so as to identify a set of the optimal inter-layer split point positions.

6. The system of claim 5, wherein the intra-layer partitioning policy for the deep learning model at least comprises:
performing partitioning according to an internal structure of at least one of the neural network layers of the deep learning model, so that at least two of the obtained partitions are deployed concurrently onto the corresponding edge servers.

7. The system of claim 6, wherein the intra-layer partitioning policy for the deep learning model at least further comprises:
partitioning convolutional layers based on a height grid of a feature map, and
partitioning a fully-connected layer based on the number of neurons.

8. A method for acceleration of deep-learning computing with edge-terminal collaboration, the method at least comprising:
when a terminal device being present in a service coverage of at least one edge server, making the terminal device determine inter-layer partitioning and/or intra-layer partitioning policy for a deep learning model based on first configuration information related to the terminal device itself and second configuration information related to the edge server; and
in response to inference request message, making the edge server execute the inter-layer partitioning and/or intra-layer partitioning policy of the deep learning model so as to implement collaborative inference.

9. The method of claim 8, further comprising:
predicting an inference execution time for a DNN layer based on a pre-trained random forest model, and deciding a set of inter-layer split point positions based on an ILP algorithm, so as to minimize a total inference time between the terminal device and the edge server; and
deciding a set of intra-layer split point positions based on a reinforcement learning algorithm DDPG and the intra-layer partitioning policy, so as to minimize the inference time between/among the edge servers.

10. The method of claim 9, further comprising:
partitioning the neural network layers of the deep learning model into at least two partitions according to inter-layer granularity.

11. The method of claim 10, further comprising:
collecting execution data of at least one of the neural network layers generated when some of the terminal devices and the edge servers execute data sets of the deep learning model, and training the random forest model for execution time of the neural network layers.

12. The method of claim 11, further comprising:
using the random forest models to predict the execution time for the terminal device and the edge server to execute the neural network layers of the deep learning model;
determining a transmission time for an intermediate feature vector between the terminal device and the edge server based on output data of each of the neural network layers of the deep learning model and communication bandwidth data of the edge server,
determining a total offloading time for the partitions based on a sum of the inference execution time and the transmission time of the intermediate feature vector, and
solving an optimal solution with the minimal total time based on the ILP algorithm, so as to identify a set of the optimal inter-layer split point positions.

13. The method of claim 12, further comprising:
performing partitioning according to an internal structure of at least one of the neural network layers of the deep learning model, so that at least two of the obtained partitions are deployed concurrently onto the corresponding edge servers.

14. The method of claim 13, further comprising:
partitioning convolutional layers based on a height grid of a feature map, and
partitioning a fully-connected layer based on the number of neurons.

15. A terminal device for performing collaborative deep-learning computing with an edge server, the terminal device being configured to:
when being present in a service coverage of the at least one edge server, determine an inter-layer partitioning and/or intra-layer partitioning policy for a deep learning model based on first configuration information related to the terminal device itself and second configuration information related to the edge server, wherein the process includes:
predicting an inference execution time for a DNN layer based on a pre-trained random forest model, and deciding a set of inter-layer split point positions based on an ILP algorithm, so as to minimize a total inference time between the terminal device and the edge server; and
deciding a set of intra-layer split point positions based on a reinforcement learning algorithm DDPG and the intra-layer partitioning policy, so as to minimize the inference time between/among the edge servers.

16. The terminal device of claim 15, wherein the terminal device is configured to:
predict an inference execution time for each neural network layer in the deep learning model based on a pre-trained random forest model, and decide a set of inter-layer split point positions based on an ILP algorithm, so as to minimize a total inference time between the terminal device and the edge server; and
decide a set of intra-layer split point positions based on a reinforcement learning algorithm and the intra-layer partitioning policy, so as to minimize the inference time between/among the edge servers.

17. The terminal device of claim 16, wherein the inter-layer partition policy for the deep learning model at least comprises:
partitioning the neural network layers of the deep learning model into at least two partitions according to inter-layer granularity.

18. The terminal device of claim 17, wherein the intra-layer partitioning policy for the deep learning model at least comprises:
collecting execution data of at least one of the neural network layers generated when some of the terminal devices and the edge servers execute data sets of the deep learning model, and training the random forest model for execution time of the neural network layers.

19. The terminal device of claim 18, wherein the terminal device is configured to decide the inter-layer split point positions at least through:
using the random forest models to predict the execution time for the terminal device and the edge server to execute the neural network layers of the deep learning model;
determining a transmission time for an intermediate feature vector between the terminal device and the edge server based on output data of each of the neural network layers of the deep learning model and communication bandwidth data of the edge server,
determining a total offloading time for the partitions based on a sum of the inference execution time and the transmission time of the intermediate feature vector, and
solving an optimal solution with the minimal total time based on the ILP algorithm, so as to identify a set of the optimal inter-layer split point positions.

20. The terminal device of claim 19, wherein the intra-layer partitioning policy for the deep learning model at least comprises:
performing partitioning according to an internal structure of at least one of the neural network layers of the deep learning model, so that at least two of the obtained partitions are deployed concurrently onto the corresponding edge servers.
